(19) United States
(12) Patent Application Publication
(10) Pub. No.: US 2026/0326649 A1
(43) Pub. Date: Oct. 22, 2026

(54) ARTICLE HOLDING DEVICE

(71) Applicant: NIFCO INC., Yokosuka-shi, Kanagawa (JP)

(72) Inventor: Yuhei CHINOMI, Yokosuka-shi, Kanagawa (JP)

(21) Appl. No.: 19/115,787

(22) PCT Filed: Sep. 19, 2023
(86) PCT No.: PCT/JP2023/033948

§ 371 Date: Mar. 27, 2025

(30) Foreign Application Priority Data
Nov. 17, 2022 (JP) 2022-183834

(51) Int. Cl. B60N 3/10

(52) U.S. Cl. CPC B60N 3/106

(57) ABSTRACT

Provided is an article holding device capable of stably holding an article. The article holding device for holding an article includes a case having a housing section housing the article therein, an arm provided to the case in a displaceable manner, and a biasing member biasing the arm. A first guide section is provided to either the case or the arm, and a first shaft section is provided to the other of the case and the arm. The first shaft section is supported by the first guide section so that the first shaft section is slidable between first and second slide position and rotatable between first and second rotational positions. The biasing member biases the first shaft section toward the first slide position and the first rotational position. The first guide section includes a restricting section.

### RELATED APPLICATIONS

The present application is a National Phase of International Application Number PCT/JP2023/033948 filed Sep. 19, 2023, and claims priority to Japanese Application Number 2022-183834 filed Nov. 17, 2022.

### FIELD

The present invention relates to an article holding device for holding articles.

### BACKGROUND

It is known to provide a container holding device that holds containers such as cans, cups, and PET bottles in a manner that prevents them from falling down (e.g., Patent Literature 1). The container holding device disclosed in Patent Literature 1 comprises a bottomed cylindrical holder that allows the container to be freely taken out upward, and a contact member that is disposed to face an opening formed in the side surface of the holder and is constantly biased in a direction in which the contact member is pressed against the peripheral wall of the container.

In the container holding device of Patent Literature 1, a case is securely fixed to the holder. The contact member is pivotally supported on a rotational center shaft formed in the case. The contact member is further provided with a guide section in the form of an elongated hole that guides the movement direction of the contact member either in the vertical direction or in a direction that allows the contact member to enter into or out from the opening.

### CITATION LIST

### Patent Literature

Patent Literature 1: Japanese Unexamined Patent Application Publication No. 2013-208961

### SUMMARY

### Technical Problem

In the container holding device disclosed in Patent Literature 1, when a load is applied from the container being held to the contact member in a direction that allows the contact member to retract, the contact member is guided by the guide section in the retracting direction into the opening. Consequently, if the load exerted on the contact member by the container exceeds the biasing force, the contact member is retracted into the opening, so that there is a problem that the container is not stably retained within the holding device.

In view of the above background, the present invention aims to provide an article holding device capable of stably holding an article.

### Solution to Problem

To address the foregoing problem, one aspect of the present invention provides an article holding device (1) configured to hold an article (3), including a case (5) having a housing section (15) configured to house the article therein, an arm (7) provided to the case in a displaceable manner, and a biasing member (111) configured to bias the arm, in which a first guide section (67) is provided to either the case or the arm, and a first shaft section (87) is provided to the other of the case and the arm, the first shaft section is supported by the first guide section so that the first shaft section is slidable between a first slide position and a second slide position and rotatable between a first rotational position and a second rotational position, the arm is positioned closer to the center of the housing section when the first shaft section is in the first slide position than when the first shaft section is in the second slide position, and the arm is positioned closer to the center of the housing section when the first shaft section is in the first rotational position than when the first shaft section is in the second rotational position, the biasing member biases the first shaft section toward the first slide position and the first rotational position, the first guide section is provided with a restricting section (71), the restricting section is configured to contact the first shaft section to restrict movement of the first shaft section from the first slide position to the second slide position when the first shaft section is in the first slide position and the first rotational position, and configured to permit the movement of the first shaft section from the first slide position to the second slide position when the first shaft section is in the first slide position and the second rotational position.

According to this aspect, an article holding device capable of stably holding an article can be provided.

In the foregoing aspect, the first guide section may be provided to the case, the first shaft section may be provided to the arm, the housing section may be a cylindrical recess that is recessed downward, the first guide section may extend in the radial direction of the housing section, have a proximal end and a distal end, and extend upward from the proximal end toward the distal end, and the first shaft section may be positioned at the proximal end in the first slide position and positioned at the distal end in the second slide position.

According to this aspect, even when the arm is positioned at a distal position with respect to the housing section, the arm can contact the article at a higher position. As a result, an article with a larger diameter can be stably held.

In the foregoing aspect, the housing section may include a bottom wall (17) and a cylindrical side wall (19) extending upward from the bottom wall, the side wall may be formed with an insertion hole (25) that penetrates the side wall in the radial direction of the housing section, allowing the arm to pass therethrough, and a base (13) on which the first guide section is formed may be provided in the outer peripheral portion of the side wall.

According to this aspect, the arm can enter the housing section through the insertion hole 25. Thus, the article can be securely held.

In the foregoing aspect, the base may be separately formed from the housing section and may be assembled to the housing section.

According to this aspect, the base can be easily assembled.

In the foregoing aspect, the restricting section may be a recess extending downward from the proximal end and include a restricting surface (73) directed toward the housing section, and the first shaft section may include a contact portion (93) configured to contact the restricting surface when the first shaft section is in the first slide position and the first rotational position and configured to be positioned above the restricting surface when the first shaft section is in the first slide position and the second rotational position.

According to this aspect, by releasing the contact portion from the restricting surface, the first shaft section can be moved from the first slide position to the second slide position.

In the foregoing aspect, the first shaft section may include a sliding surface (91) configured to incline with respect to the restricting surface and extend upward toward the distal end beyond the restricting surface when the first shaft section is in the first slide position and the second rotational position.

According to this aspect, the first shaft section is more easily moved from the first slide position to the second slide position. Thus, an article with a large diameter can be easily held.

In the foregoing aspect, the length of the sliding surface may be greater than the width of the first guide section in the direction perpendicular to the longitudinal direction of the first guide section when viewed in the axial direction of the first shaft section.

According to this aspect, when the first shaft section rotates beyond the second rotational position, the first shaft section can be restricted from moving from the first slide position to the second slide position.

In the foregoing aspect, a lower arm (83) may be provided below the arm so as to be connected to the arm in a rotatable manner and connected to the base in a slidable manner, the base may include a second guide section (69) extending in the vertical direction, the lower arm may include a second shaft section (105) supported by the second guide section in a vertically movable manner, and the biasing member may be connected to the arm and the lower arm to bias the first shaft section toward the first slide position and the first rotational position and bias the second shaft section toward the upper end of the second guide section.

According to this aspect, the arm is supported by the first guide section and the lower arm is supported by the second guide section. Thus, the motion of the arm is stabilized.

In the foregoing aspect, the lower arm may include a plate section (103) facing the insertion hole.

According to this aspect, it is possible to prevent components of the article from falling out of the housing section through the insertion hole.

Advantageous Effects of Invention According to the present invention, it is possible to provide an article holding device capable of stably holding an article.

### BRIEF DESCRIPTION OF DRAWINGS

FIG. 1 is a perspective view of an article holding device.

FIG. 2 is a perspective view of a base.

FIG. 3 is a front view of the base.

FIG. 4 (A) and 4 (B) are side views illustrating displacement of an arm relative to a case.

FIG. 5 (A) and 5 (B) are side views illustrating the displacement of the arm relative to the case.

### DESCRIPTION OF EMBODIMENTS

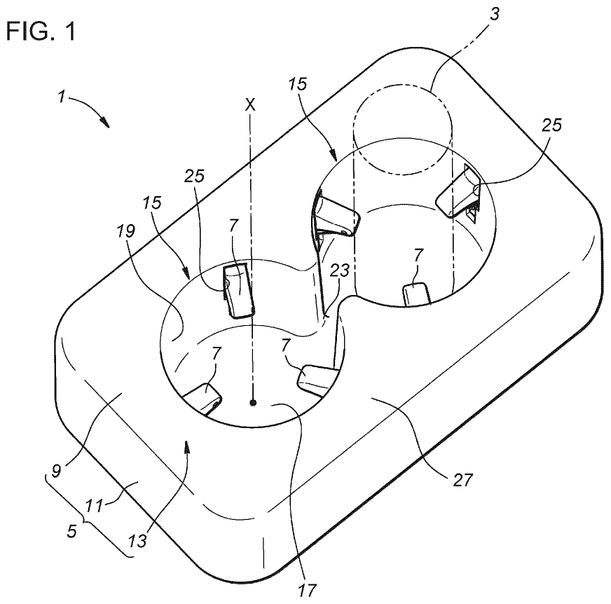

Embodiments of an article holding device 1 according to the present invention will be described below with reference to the drawings. As illustrated in FIG. 1, the article holding device 1 is configured to hold an article 3, such as a beverage container. The article holding device 1 is installed, for example, by being fixed to the center console of a vehicle interior. The article holding device 1 includes a case 5 and an arm 7 that is provided to the case 5 in a displaceable manner.

The case 5 includes a case body 9 and at least one base 13.

The case body 9 includes an upper wall 27 and a lateral wall 11 connected to the upper wall 27.

The upper wall 27 has a surface directed upward and is rectangular in a plan view. In the upper wall 27, housing sections 15 recessed downward are formed. In the present embodiment, two housing sections 15 are formed in positions adjacent each other in the upper wall 27.

The lateral wall 11 is connected to the edge of the upper wall 27 and extends in the vertical direction. That is, the lateral wall 11 laterally surrounds the housing sections 15.

Each of the housing sections 15 includes a bottom wall 17 defining the bottom of the housing section 15 and a side wall 19 extending upward from the bottom wall 17. The side wall 19 is connected to the upper wall 27 and has a cylindrical shape. Accordingly, the housing section 15 constitutes a cylindrical recess that is recessed downward. A user can place the article 3 in the housing section 15.

The bottom wall 17 has a disc shape with a horizontal orientation. Hereinafter, the axis X, which vertically passes through the center of the disc (i.e., the center of the housing section 15), will be used as a reference. The direction approaching the axis X will be referred to as a proximal side, and the direction moving away from the axis X will be referred to as a distal side.

The side wall 19 includes a groove 23 extending in a circumferential direction and a vertical direction of the bottom wall 17. In the present embodiment, one of the housing sections 15 is in communication with the other housing section 15 through the groove 23. Since the two housing sections 15 have the same configuration, the following description will focus on one of the two housing sections 15.

In the side wall 19, a plurality of insertion holes 25 is formed. The insertion holes 25 are through holes elongated in the vertical direction, penetrating the housing section 15 in the radial direction. The insertion holes 25 may be formed in the central portion of the side wall 19 in the vertical direction. The insertion holes 25 may also be arranged at equal intervals in the circumferential direction of the bottom wall 17.

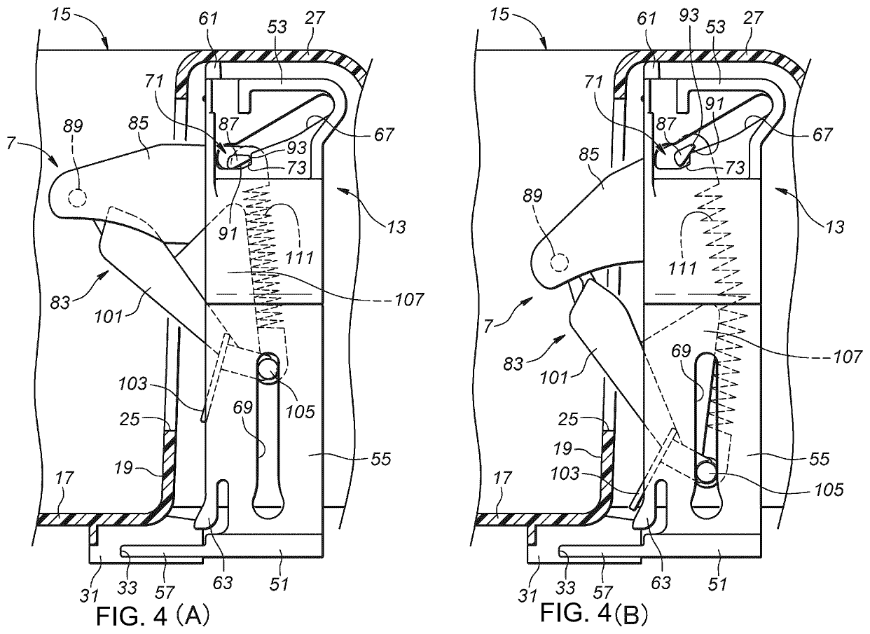

As illustrated in FIG. 4(A), 4(B), 5(A) and 5(B), legs 31 are formed on the lower surface of the bottom wall 17. The legs 31 are provided at positions aligned with the insertion holes 25 in the circumferential direction. The legs 31 each extend downward toward the outside in the radial direction from the edge of the bottom wall 17. The legs 31 each include a receiving groove 33 that is open toward the outside in the radial direction.

As illustrated in FIGS. 1 to 3, the bases 13 are provided in the outer peripheral portion of the side wall 19. The bases 13 are separately formed from the case body 9 (i.e., the housing section 15) and are assembled to the case body 9 (i.e., the housing section 15). The bases 13 may be formed, for example, by integral molding.

The bases 13 each include a lower member 51 and an upper member 53 that face each other and a pair of side members 55 connecting the lower member 51 to the upper member 53. On the lower member 51, an extension section 57 extending in a first direction is formed. On the upper member 53, a protrusion 61 is formed.

The protrusion 61 is provided on the upper surface of the upper member 53 and projects upward. The protrusion 61 is formed on the first direction side in the upper member 53.

The side members 55 making a pair are arranged in parallel with each other. Each of the side members 55 making a pair includes a locking piece 63, a first guide section 67, and a second guide section 69.

The locking pieces 63 are formed in the first direction side of the lower portions of the side members 55. The locking pieces 63 extend downward in the first direction.

Each of the first guide sections 67 and the second guide sections 69 is defined by a through-hole formed in the pair of side members 55. The first guide sections 67 are formed at positions facing each other, and the second guide sections 69 are formed at positions facing each other.

As illustrated in FIG. 4(A), 4(B), 5(A) and 5(B), the first guide sections 67 extend upward from the first direction side to a second direction opposite to the first direction at the upper portions of the side members 55. It is preferred that the first guide sections 67 are inclined upward from the first direction side to the second direction. Restricting sections 71 are provided at the ends in the first direction side of the first guide sections 67.

The restricting sections 71 are recesses formed in the side members 55 and extend downward from the ends in the first direction side of the first guide sections 67. In other words, the length of the first guide section 67 in the vertical direction is greater on the first direction side than on the second direction side. The restricting sections 71 each include a restricting surface 73 directed toward the first direction side.

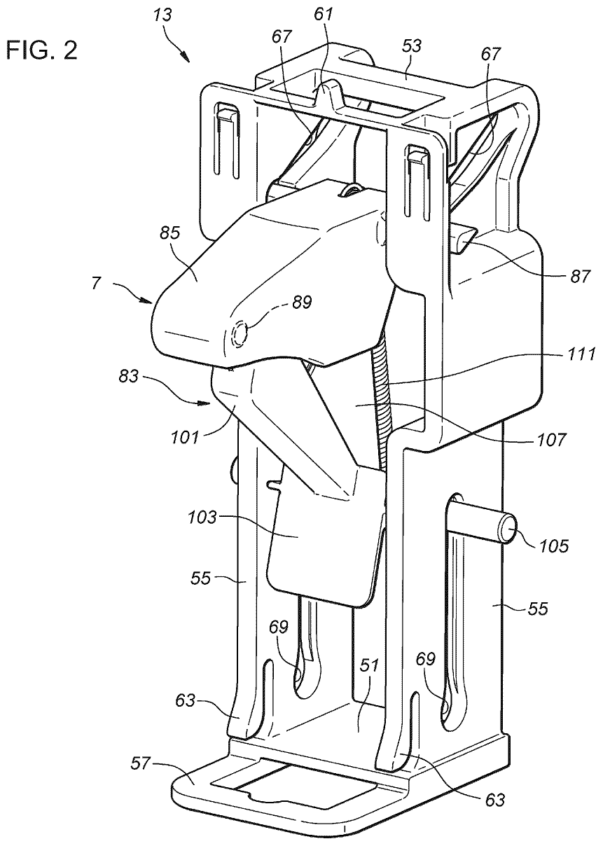

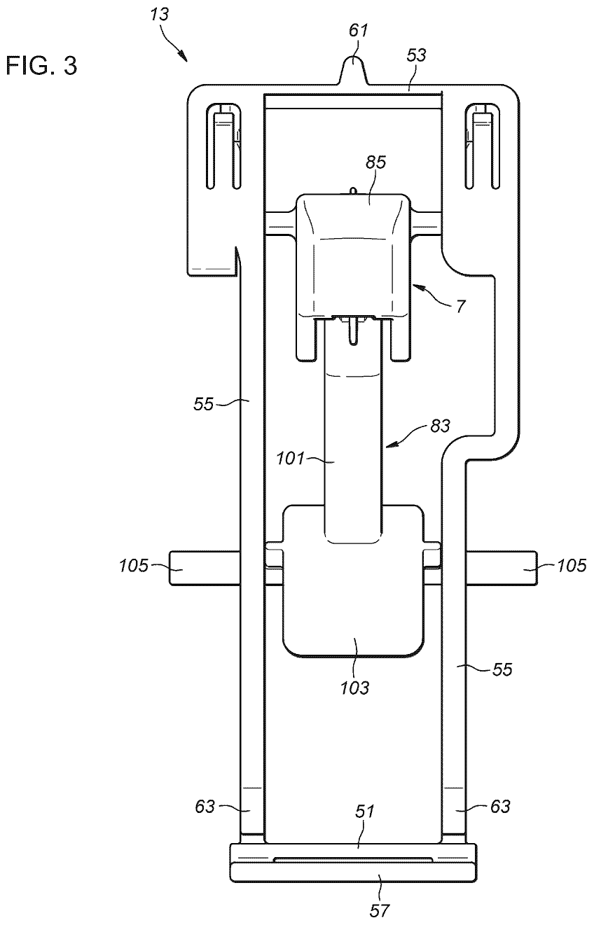

As illustrated in FIGS. 2 and 3, the second guide sections 69 extend in the vertical direction at the lower portions of the side members 55. It is preferred that the length from the end in the first direction to the end in the second direction of the second guide section 69 is expanded at the lower end relative to the upper end.

The base 13 supports the arm 7 with the first guide sections 67 and the second guide sections 69. The arm 7 is interposed between the pair of side members 55. It is preferred that the arm 7 is separately formed from the base 13 and assembled to the base 13.

The arm 7 includes an arm body 85 and a first shaft section 87 connected to the arm body 85.

The arm body 85 is supported on the base 13 so as to be projectable in the first direction. A lower arm 83 is rotatably connected to an end (entry end) in the first direction side of the arm body 85 via a hinge shaft 89.

The first shaft section 87 is formed at an end in the second direction side of the arm body 85. The first shaft section 87 laterally extends from both side surfaces of the arm body 85. The first shaft section 87 is slidably and rotatably supported by the first guide sections 67.

As illustrated in FIG. 4(A), 4(B), 5(A) and 5(B), the first shaft section 87 has a triangular cross-sectional shape. In the present embodiment, the cross-sectional shape of the first shaft section 87 is a right triangle. The surface forming the hypotenuse of the right triangle defining the sectional shape of the first shaft section 87 functions as a sliding surface 91 that contacts the restricting section 71. The end forming the angle on the second direction side among the two angles at both ends of the hypotenuse of the right triangle defining the sectional shape of the first shaft section 87 functions as a contact portion 93 that contacts the restricting surface 73.

The first shaft section 87 is movable between a first slide position and a second slide position, the first slide position is positioned at the end in the first direction side (i.e., the proximal end) of the first guide section 67, and the second slide position is positioned at the end in the second direction side (i.e., the distal end) of the first guide section 67. At the first slide position, the first shaft section 87 is rotatable between a first rotational position (FIG. 4(A)) and a second rotational position (FIG. 4(B)).

The first rotational position means a position where the contact portion 93 contacts the restricting section 71, thereby restricting the movement of the first shaft section 87, and in which the sliding surface 91 is inclined upward from the first direction toward the second direction. The second rotational position means a position where the sliding surface 91 contacts the restricting section 71 and in which the sliding surface 91 is further inclined upward than in the first rotational position.

As illustrated in FIGS. 2 and 3, the lower arm 83 is provided below the arm 7. The lower arm 83 includes a lower arm body 101, a plate section 103 formed at the lower part of the lower arm body 101, a second shaft section 105 connected to the lower arm body 101, and a sound-damping section 107.

The lower arm body 101 is supported so as to be projectable in the first direction relative to the base 13.

The plate section 103 has a rectangular main surface and is formed in a plate shape. The plate section 103 is directed in the first direction and inclined upward. The plate section 103 is connected, at the upper part thereof, to the lower arm body 101.

The second shaft section 105 is formed at the end in the second direction side of the lower arm body 101. The second shaft section 105 is provided in the second direction side beyond the plate section 103. The second shaft section 105 is supported by the second guide section 69 in a vertically slidable manner. The second shaft section 105 is provided so as to be slidable between an upper-end position at the upper end of the second guide section 69 and a lower-end position at the lower end of the second guide section 69. The second shaft section 105 extends parallel to the first shaft section 87. The lower arm 83 is connected to the arm 7 via a biasing member 111 at the second shaft section 105.

The biasing member 111 connects the first shaft section 87 to the second shaft section 105. The biasing member 111 biases the first shaft section 87 toward the first slide position and the first rotational position and biases the second shaft section 105 toward the upper end of the second guide section 69. In other words, the biasing member 111 biases the first shaft section 87 and the second shaft section 105 toward one another. The biasing member 111 may be, for example, a tension coil spring.

The sound-damping section 107 is provided on the second direction side of the lower arm body 101. The upper part of the sound-damping section 107 may be received from above by the arm body 85. The end in the second direction side of the sound-damping section 107 contacts the biasing member 111. The sound-damping section 107 may project to the second direction side to contact the biasing member 111. The end in the second direction side of the sound-damping section 107 may have a groove configured to contact and engage the biasing member 111.

As illustrated in FIGS. 1, 4(A), 4(B), 5(A) and 5(B), the bases 13 are provided along the outer surface of the side wall 19. Each base 13 is arranged such that the first direction thereof is on the proximal side relative to the axis X, and the second direction thereof is on the distal side relative to the axis X. The positional relationship between the case body 9 and the base 13 will be described below.

The base 13 is positioned in the circumferential direction of the bottom wall 17 at the position aligned with the insertion hole 25 and the leg 31. The extension section 57 is directed inward and inserted into the receiving groove 33 from below and the distal side. As a result, the displacements of the base 13 relative to the case body 9 in the upward, left-right, and radially inward directions are restricted.

The locking piece 63 engages the upper surface of the leg 31 from above. As a result, the displacement of the base 13 relative to the case body 9 in the downward direction is restricted.

The upper member 53 is positioned below the upper wall 27. The end in the proximal side of the upper member 53 contacts the outer surface of the side wall 19. As a result, the displacement of the base 13 relative to the case body 9 in the radially inward direction is restricted.

The protrusion 61 engages the lower surface of the upper wall 27 from below. As a result, the displacement of the base 13 relative to the case body 9 in the upward direction is restricted.

Locking grooves opening downward, not illustrated in the drawings, may be formed in positions on the lower surface of the upper wall 27 at the distal side to the side wall 19. It is preferred that the locking grooves are provided at positions aligned with the insertion holes 25 in the circumferential direction. The base 13 may be engaged with the case body 9 by fitting the protrusion 61 to the locking groove.

When the base 13 is attached to the case body 9, the arm 7 passes through the insertion hole 25 and enters the housing section 15.

Next, the displacement of the arm 7 relative to the case 5 when the article 3 is housed in the housing section 15 will be described.

FIG. 4(A) illustrates the position of the arm 7 when no article 3 is housed in the housing section 15 (see FIG. 1). The arm body 85 horizontally enters the housing section 15. The first shaft section 87 is put in the first slide position and the first rotational position in the first guide section 67. The second shaft section 105 is put in the upper-end position in the second guide section 69. The plate section 103 faces the insertion hole 25.

In the first rotational position, the contact portion 93 contacts the restricting surface 73. As a result, in the first rotational position, the movement of the first shaft section 87 from the first slide position to the second slide position is restricted.

When the user places the article 3 in the housing section 15, the article 3 is supported from below by the bottom wall 17. At least the lower part of the article 3 is laterally surrounded by the side wall 19.

When the user places the article 3 with a relatively small diameter (hereinafter referred to as “small-diameter article”) in the housing section 15, the arm 7 can hold the small-diameter article in a state where the first shaft section 87 is in the first rotational position. A small-diameter article may be, for example, a beverage can with an outer diameter of 50 mm and a capacity of 250 ml.

When the user houses the article 3 with a large diameter (hereinafter referred to as “large-diameter article”) in the housing section 15, the load of the large-diameter article is applied to the entry end of the arm 7 from above. At this time, as the first shaft section 87 rotates inward, the sliding surface 91 inclines with respect to the restricting surface 73. As a result, the contact between the contact portion 93 and the restricting surface 73 is released. Furthermore, the second shaft section 105 slides to move downward. Consequently, the arm 7 is displaced from the state illustrated in FIG. 4(A) to the state illustrated in FIG. 4(B) (FIG. 4(B)). A large-diameter article may be, for example, a beverage bottle with an outer diameter of 70 mm and a capacity of 500 ml.

As illustrated in FIG. 4(B), when the arm 7 enters the housing section 15 with directing downward, the first shaft section 87 is put in the first slide position and the second rotational position in the first guide section 67. The second shaft section 105 is put in a position near the lower end of the second guide section 69. The arm 7 is positioned at a distal position with respect to the axis X than when the first shaft section 87 is in the first rotational position. Compared to the state illustrated in FIG. 4(A), the biasing member 111 is vertically stretched and contacts the sound-damping section 107, thereby being bent toward the distal side relative to the axis X.

In the second rotational position, the sliding surface 91 inclines with respect to the restricting surface 73 and extends upward toward the distal end beyond the restricting surface 73. The contact portion 93 is positioned above the restricting surface 73. As a result, the restricting section 71 allows the first shaft section 87 to move from the first slide position to the second slide position. When the user attempts to house the large-diameter article in the housing section 15 from this state, the first shaft section 87 moves upward toward the distal side relative to the restricting section 71. In other words, as the sliding surface 91 slides over the restricting section 71, the first shaft section 87 overcomes the restricting section 71, thereby being released from the restriction, and thus the first shaft section 87 can move from the first slide position to the second slide position.

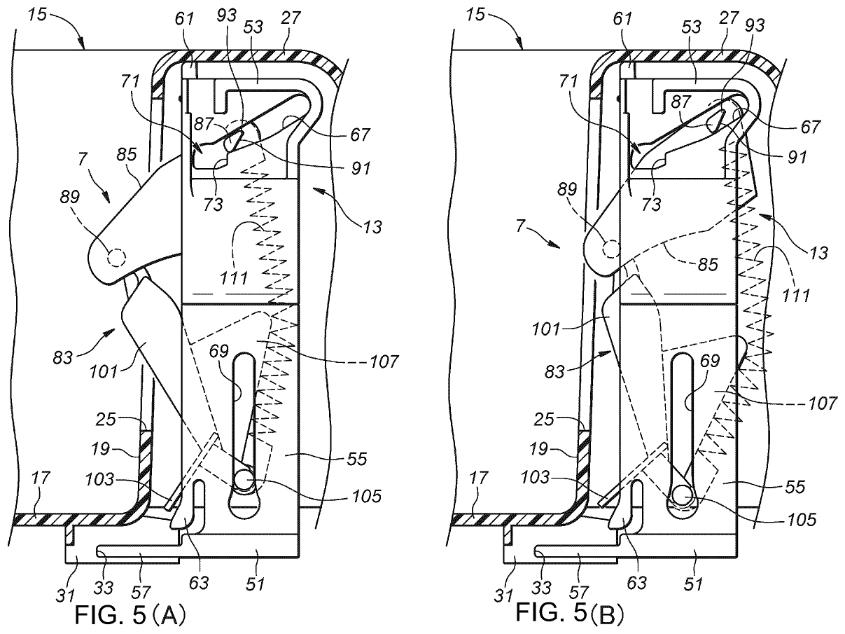

FIG. 5(A) illustrates the position of the arm 7 while the first shaft section 87 is moving from the first slide position to the second slide position. The first shaft section 87 is positioned between the first slide position and the second slide position in the first guide section 67. The second shaft section 105 is put in a position near the lower end of the second guide section 69.

FIG. 5(B) illustrates the position of the arm 7 when the first shaft section 87 has moved to the second slide position. The second shaft section 105 is put in the lower-end position in the second guide section 69. The plate section 103 is inclined upward as compared to the state illustrated in FIG. 4(A). The arm 7 is positioned at a distal position with respect to the axis X than when the first shaft section 87 is in the first slide position. The biasing member 111 is further stretched in the vertical direction as compared to the state illustrated in FIG. 4(B) and contacts the sound-damping section 107, thereby being bent farther toward the distal side relative to the axis X.

When the user houses a large-diameter article in the housing section 15, the arm 7 can hold the large-diameter article in the position illustrated in FIG. 5(B).

Additionally, if the article 3 to be housed in the housing section 15 has a reduced diameter from the lower part toward the upper part (a constricted article), the arm 7 moves to the position illustrated in FIG. 5(B). Thereafter, the arm 7 returns to the position illustrated in FIG. 5(A) and can hold the article 3.

As described above, the entry length of the arm 7 into the housing section 15 varies depending on the position of the first shaft section 87 relative to the first guide section 67.

Next, the effects of the article holding device 1 according to the present embodiment will be described. The article holding device 1 includes the case 5 having the housing section 15 configured to house the article 3 therein, and the arm 7 provided to the case 5 in a displaceable manner. The case 5 is provided with the first guide section 67, and the arm 7 is provided with the first shaft section 87. The first shaft section 87 is supported by the first guide section 67, and is biased toward the first slide position and the first rotational position by the biasing member 111. The restricting section 71 contacts the first shaft section 87 when the first shaft section 87 is in the first slide position and the first rotational position, thereby restricting the movement of the first shaft section 87 from the first slide position to the second slide position. The restricting section 71 allows the first shaft section 87 to move from the first slide position to the second slide position when the first shaft section 87 is in the first slide position and the second rotational position.

According to this configuration, the arm 7 is biased by the biasing member 111 so that the first shaft section 87 is put in the first slide position and the first rotational position. In this state, the restricting section 71 contacts the first shaft section 87 and restricts the movement of the first shaft section 87 from the first slide position to the second slide position. Accordingly, the arm 7 is restricted from moving in the distal direction with respect to the housing section 15. As a result, when the article 3 is housed in the housing section 15, the movement of the arm 7 is prevented. Therefore, the article 3 with a small diameter relative to the diameter of the housing section 15 can be stably held. Additionally, when a load from the article 3 is applied to the arm 7 and therefore the first shaft section 87 rotates to the first slide position and the second rotational position, the restricting section 71 allows the first shaft section 87 to move from the first slide position to the second slide position. Accordingly, the arm 7 moves toward the distal side relative to the housing section 15. As a result, the article 3 with a larger diameter can be housed in the housing section 15 without lowering the contact position between the arm 7 and the article 3. Therefore, the article 3 with a large diameter relative to the diameter of the housing section 15 can be stably held. Thus, it is possible to provide the article holding device 1 capable of stably holding the article 3.

The first guide section 67 extends in the radial direction of the housing section 15 and has a proximal end on the proximal side and a distal end on the distal side relative to housing section 15, extending from the proximal end toward the distal end. The first shaft section 87 is positioned at the proximal end in the first slide position and at the distal end in the second slide position. With this configuration, when the first shaft section 87 is positioned at the distal end, the arm 7 can be positioned upward. Accordingly, even when the arm 7 is positioned in the distal side relative to the housing section 15, the arm 7 can contact the article 3, at a higher position. Therefore, the article 3 with a large diameter can be held with even greater stability.

The side wall 19 is formed with the insertion hole 25 that penetrates the side wall 19 in the radial direction of the housing section 15 through which the arm 7 passes, and the outer peripheral portion of the side wall 19 is provided with the base 13 in which the first guide section 67 is formed. With this configuration, the arm 7 can enter the housing section 15 through the insertion hole 25. Thus, the article 3 can be securely held.

The bases 13 are separately formed from the case body 9, in which the housing sections 15 are formed, and are assembled to the case body 9. With this configuration, the base 13 can be easily assembled to the housing section 15.

The contact portion 93 contacts the restricting surface 73 when the first shaft section 87 is in the first slide position and the first rotational position, and is positioned above the restricting surface 73 when the first shaft section 87 is in the first slide position and the second rotational position. With this configuration, releasing the contact between the contact portion 93 and the restricting surface 73 by rotating the first shaft section 87 allows the first shaft section 87 to move from the first slide position to the second slide position. As a result, the arm 7 can be moved away from the center of the housing section 15.

The sliding surface 91 inclines with respect to the restricting surface 73 and extends upward toward the distal end beyond the restricting surface 73 when the first shaft section 87 is in the first slide position and the second rotational position. With this configuration, when the first shaft section 87 moves from the first slide position to the second slide position, the sliding surface 91 facilitates the first shaft section 87 in riding over the restricting section 71. Hence, the movement of the arm 7 is facilitated, so that the article 3 having a large diameter can be easily held.

The biasing member 111 is connected to the arm 7 and the lower arm 83, urging the first shaft section 87 toward the first slide position and the first rotational position and also urging the second shaft section 105 toward the upper end of the second guide section 69. According to this configuration, the arm 7 is supported by the first guide section 67, and the lower arm 83 is supported by the second guide section 69. Thus, the motion of the arm 7 is stabilized.

The sound-damping section 107 contacts the biasing member 111. With this configuration, vibrations generated by the expansion and contraction of the biasing member 111 can be suppressed. As a result, noise generated when the article 3 is housed in the housing section 15 or the article 3 is taken out from the housing section 15 can be reduced.

The lower arm 83 includes the plate section 103 that faces the insertion hole 25. With this configuration, it is possible to prevent the components or the like of the article 3 from falling out of the housing section 15 through the insertion hole 25.

As a modification of the present embodiment, the length of the sliding surface 91 may be made larger than the width of the first guide section 67 in the direction perpendicular to the longitudinal direction of the first guide section 67 when viewed from the axial direction of the first shaft section 87. With this modification, when the first shaft section 87 rotates beyond the second rotational position, the first shaft section 87 is restricted from moving from the first slide position to the second slide position. In other words, when a force is intensely applied to the arm 7, the movement of the arm 7 from the first slide position to the second slide position can be prevented.

The description of the specific embodiment concludes here; however, the present invention is not limited to the above embodiment and may be modified in various ways. The housing section 15 of the case body 9 may be a single unit. The first guide section 67 may be formed on the arm 7, and the first shaft section 87 may be formed on the base 13. The sound-damping section 107 may be provided on the arm 7, the base 13, or the case body 9, instead of being provided on the lower arm body 101.

1. An article holding device configured to hold an article, comprising:
a case having a housing section configured to house the article therein;
an arm provided to the case in a displaceable manner; and
a biasing member configured to bias the arm, wherein
a first guide section is provided to either the case or the arm, and a first shaft section is provided to another of the case and the arm,
the first shaft section is supported by the first guide section so that the first shaft section is slidable between a first slide position and a second slide position and rotatable between a first rotational position and a second rotational position,
the arm is positioned closer to a center of the housing section when the first shaft section is in the first slide position than when the first shaft section is in the second slide position, and the arm is positioned closer to the center of the housing section when the first shaft section is in the first rotational position than when the first shaft section is in the second rotational position,
the biasing member biases the first shaft section toward the first slide position and the first rotational position,
the first guide section is provided with a restricting section, and
the restricting section is configured to contact the first shaft section to restrict movement of the first shaft section from the first slide position to the second slide position when the first shaft section is in the first slide position and the first rotational position, and configured to permit the movement of the first shaft section from the first slide position to the second slide position when the first shaft section is in the first slide position and the second rotational position.

2. The article holding device according to claim 1, wherein
the first guide section is provided to the case,
the first shaft section is provided to the arm,
the housing section is a cylindrical recess that is recessed downward,
the first guide section extends in a radial direction of the housing section, has a proximal end and a distal end, and extends upward from the proximal end toward the distal end, and
the first shaft section is positioned at the proximal end in the first slide position and positioned at the distal end in the second slide position.

3. The article holding device according to claim 2, wherein
the housing section includes a bottom wall and a cylindrical side wall extending upward from the bottom wall,
the side wall is formed with an insertion hole that penetrates the side wall in the radial direction of the housing section, allowing the arm to pass therethrough, and
a base on which the first guide section is formed is provided in an outer peripheral portion of the side wall.

4. The article holding device according to claim 3, wherein the base is separately formed from the housing section and is assembled to the housing section.

5. The article holding device according to claim 2, wherein
the restricting section is a recess extending downward from the proximal end and includes a restricting surface directed toward the housing section, and
the first shaft section includes a contact portion configured to contact the restricting surface when the first shaft section is in the first slide position and the first rotational position and configured to be positioned above the restricting surface when the first shaft section is in the first slide position and the second rotational position.

6. The article holding device according to claim 5, wherein the first shaft section includes a sliding surface configured to incline with respect to the restricting surface and extend upward toward the distal end beyond the restricting surface when the first shaft section is in the first slide position and the second rotational position.

7. The article holding device according to claim 6, wherein a length of the sliding surface is greater than a width of the first guide section in a direction perpendicular to a longitudinal direction of the first guide section when viewed in an axial direction of the first shaft section.

8. The article holding device according to claim 3, wherein
a lower arm is provided below the arm so as to be connected to the arm in a rotatable manner and connected to the base in a slidable manner,
the base includes a second guide section extending in a vertical direction,
the lower arm includes a second shaft section supported by the second guide section in a vertically movable manner, and
the biasing member is connected to the arm and the lower arm to bias the first shaft section toward the first slide position and the first rotational position and bias the second shaft section toward the upper end of the second guide section.

9. The article holding device according to claim 8, wherein the lower arm includes a plate section facing the insertion hole.
